(19) United States
(12) Patent Application Publication
(10) Pub. No.: US 2007/0108233 A1
(43) Pub. Date: May 17, 2007

(54) SPRAY TEXTURING SYSTEM

(75) Inventor: Monte Grayden, Woodbury, MN (US)

Correspondence Address: SCHWEGMAN, LUNDBERG, WOESSNER & KLUTH, P.A., P.O. BOX 2938, MINNEAPOLIS, MN, 55402, US

(73) Assignee: Allied Products. Biz LLC

(21) Appl. No.: 11/537,342

(22) Filed: Sep. 29, 2006

Related U.S. Application Data
(60) Provisional application No. 60/722,102, filed on Sep. 30, 2005.

(51) Int. Cl. B67D 5/06

(52) U.S. Cl. 222/181.1

(57) ABSTRACT

A spray texture system and method is shown. Embodiments of spray texture systems and methods as described provide for refilling of a hopper. Spray texture systems and methods are also shown that are easier to support and spread the weight of system components to other parts of a user's body. Other features include seals that prevent drying out of compound, allowing a user to clean equipment less frequently. Multiple types of compound are possible with spray texture systems and methods shown, providing more device flexibility.

### RELATED APPLICATION

This patent claims the benefit of U.S. Provisional Patent Application Ser. No. 60/722,102 filed Sep. 30, 2005, which is incorporated herein by reference.

### TECHNICAL FIELD

This invention relates to sprayer devices for applying a textured coating to a surface. Specifically, embodiments of the invention relate to spraying coatings for textured ceilings and/or walls; spraying stucco material; and spraying drywall compound.

### BACKGROUND

Current designs of texture compound sprayers are handheld. Due to the weight of a volume of compound to be sprayed, a user may have difficulty holding and aiming the sprayer. Further, when larger surfaces are coated, current spray systems need to be frequently refilled. Another drawback to current systems is the need for labor intensive cleaning at the end of a work day in order to prevent the drying out of residue spray compound left on equipment surfaces and/or unused excess spray compound left in hoppers. Current systems are also optimized for a small range of potential compound viscosities. What is needed is an improved texture compound spray system that addresses these and other concerns.

### BRIEF DESCRIPTION OF THE DRAWINGS

FIG. 1 shows an isometric view of a spray texture gun and hopper according to the prior art.

FIG. 2A shows a side view of a spray texture system according to an embodiment of the invention.

FIG. 2B shows an isometric view of a reservoir component according to an embodiment of the invention.

FIG. 2C shows a front view of the reservoir component according to an embodiment of the invention.

FIG. 3A shows an isometric view of a spray texture system according to an embodiment of the invention.

FIG. 3B shows another isometric view of a spray texture system according to an embodiment of the invention.

FIG. 4A shows an isometric view of a spray texture system according to an embodiment of the invention.

FIG. 4B shows a close up view of a spray texture system from FIG. 4A according to an embodiment of the invention.

FIG. 4C shows an isometric view of a spray texture system according to an embodiment of the invention.

FIG. 4D shows a top view of a spray texture system according to an embodiment of the invention.

FIG. 4E shows a side view of the spray texture system of FIG. 4D according to an embodiment of the invention.

FIG. 5 shows an illustration of a user with a spray texture system according to an embodiment of the invention.

FIG. 6 shows a side view of a spray texture gun according to an embodiment of the invention.

FIG. 7 shows a side view of another spray texture gun according to an embodiment of the invention.

FIG. 8A shows an isometric view of a spray texture system according to an embodiment of the invention.

FIG. 8B shows another isometric view of a spray texture system according to an embodiment of the invention.

### DETAILED DESCRIPTION

In the following detailed description, reference is made to the accompanying drawings which form a part hereof, and in which is shown, by way of illustration, specific embodiments in which the invention may be practiced. In the drawings, like numerals describe substantially similar components throughout the several views. These embodiments are described in sufficient detail to enable those skilled in the art to practice the invention. Other embodiments may be utilized and structural, mechanical or logical changes, etc. may be made without departing from the scope of the present invention.

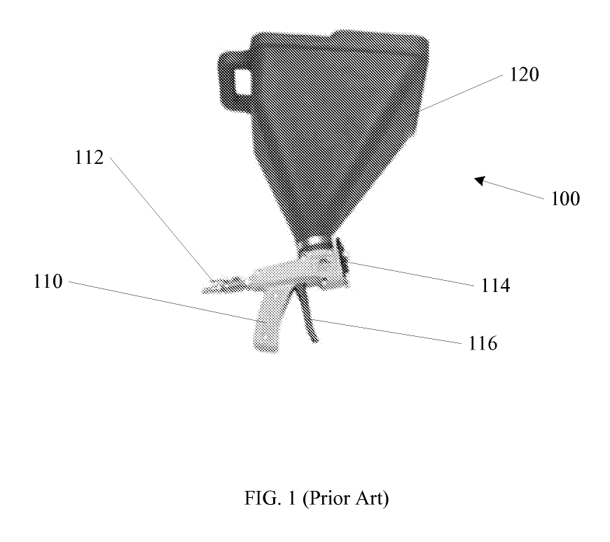

FIG. 1 shows a spray texture assembly 100 similar to a number of designs currently available. A gun handle or base 110 is shown with a pressurized air coupling 112. In some examples, the air coupling 112 includes a selectively actuated valve to control the supply of air. A hopper 120 is shown coupled to the top of the base 110. In use, gravity feeds an amount of compound down through the hopper 120 into the base 110 where pressurized air sprays the compound out through a nozzle 114. In the embodiment shown, the nozzle 114 includes a number of port selection sizes mounted on a wheel. Embodiments of the present invention can be used with a spray texture assembly such as spray texture assembly 100, although the invention is not so limited. Other guns, hoppers, spray texture assemblies, etc. are compatible with embodiments of the invention as will be described below. For illustration purposes, the spray texture assembly 100 as shown in FIG. 1 is used as an example in selected embodiments of the invention.

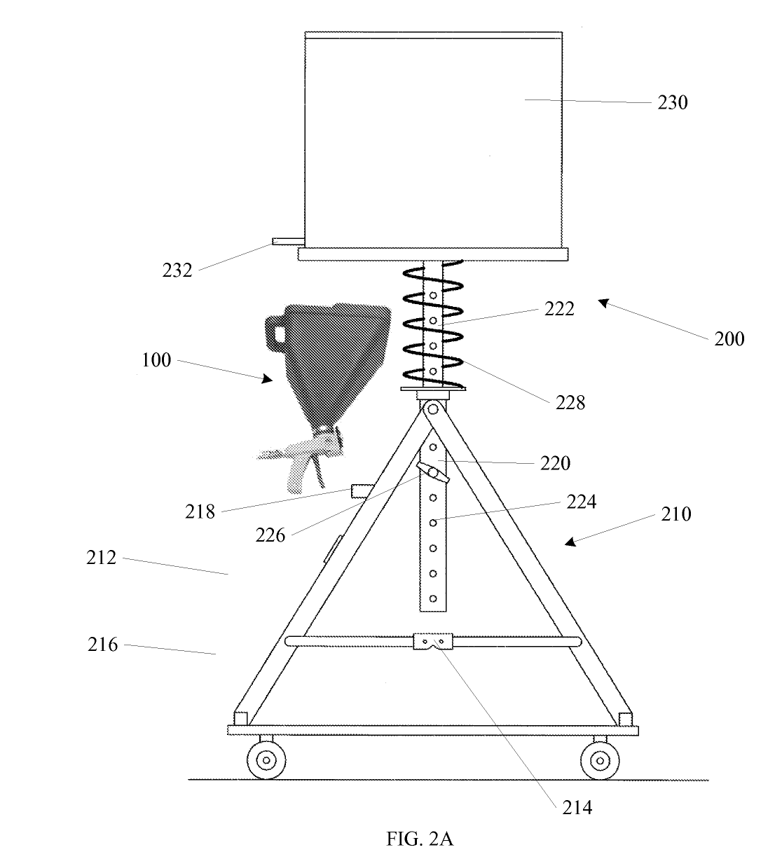

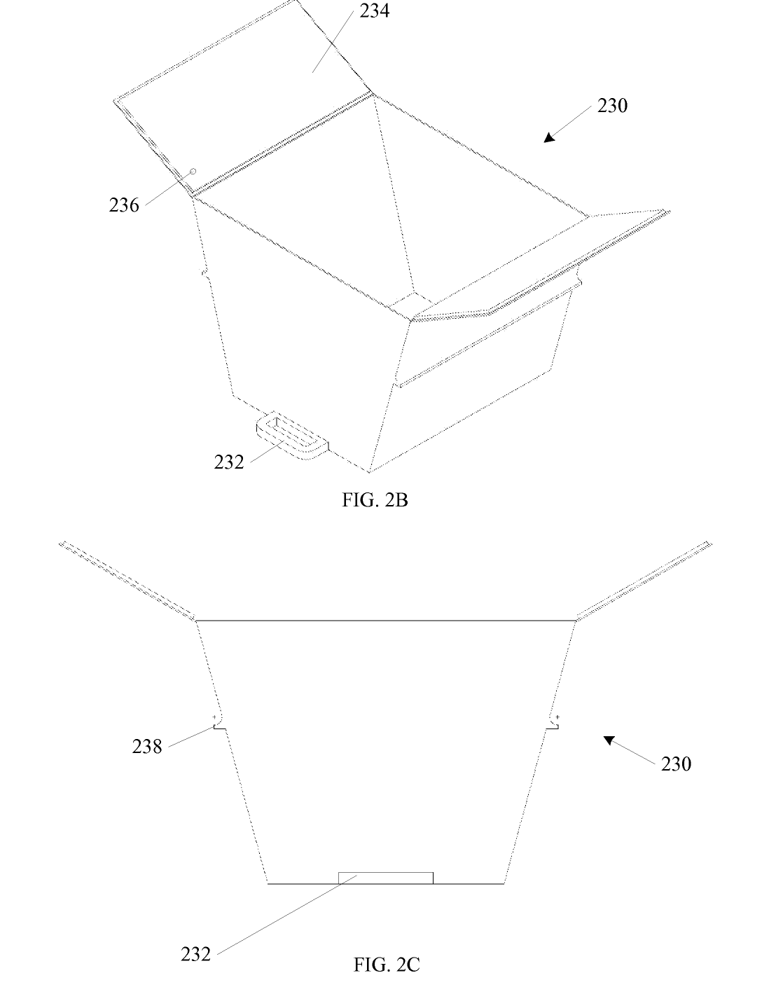

FIG. 2A shows a spray texture system 200 according to an embodiment of the invention. A cart 210 is shown supporting a reservoir 230. A spray texture assembly 100 such as the example shown in FIG. 1 is included in FIG. 2A to illustrate use in conjunction with other components in FIG. 2A. A support 218 shaped to accept the spray texture assembly 100 is shown coupled to the cart 210. In use, the spray texture assembly 100 is placed on the support 218, and the support 218 holds the hopper in a substantially upright position adjacent to the reservoir 230. The reservoir contains a supply of spray texture compound (not shown) for use in periodically filling the hopper. One common spray texture compound includes compound for forming indoor ceiling or wall patterns such as “popcorn” texture, although the invention is not so limited. Other spray texture compounds include exterior stucco, and smooth texture interior drywall mud for spraying level five flat surfaces, etc.

FIG. 2A includes a user controlled mechanism 232 to selectively release an amount of the spray texture compound from the reservoir 230 into the hopper. FIG. 2A shows an embodiment where the user controlled mechanism 232 includes a sliding door that opens or closes a port in the bottom of the reservoir 230. Although a port and a door are shown other user controlled mechanisms are within the scope of the invention including, but not limited to rotating shutters, valves, etc. In FIG. 2A, the spray texture assembly 100 is located substantially below the reservoir 230. In alternative embodiments, the spray texture assembly 100 is located in front and below the reservoir 230 with a port directing spray texture compound into the hopper.

The cart 210 in FIG. 2A includes a number of frame members 212. In one embodiment, the cart 210 includes a folding mechanism 214 such as a hinged frame member. Embodiments that include a foldable or otherwise collapsible cart have a benefit of being easy to transport and/or ship. In one embodiment, the cart 210 includes one or more wheels 216 to facilitate movement of the cart around a job site.

An optional height adjustment mechanism is also shown in FIG. 2A. The particular height adjustment in FIG. 2A includes a first shaft 220 and a second shaft 222 that telescope together. A plurality of indexing features 224 such as holes provide a number of secure selectable height positions. A securing device such as a pin 226 is shown interfacing with holes 224 to secure the position shown in FIG. 2A. In one embodiment, a spring 228 is included to counter the weight of the reservoir 230 and facilitate a height adjustment operation. One ordinary skill in the art having the benefit of the present disclosure will recognize that a number of height adjustment mechanisms are possible within the scope of the invention. For example, various springs other than a coil spring 228 such as a leaf spring or a compressed gas spring, etc. may be used. Other securing devices such as a ratchet, a clamp, etc. may also be used. In place of telescoping members, other linkages such as folding linkages or threaded extenders may be used.

FIG. 2B shows one embodiment of the reservoir 230 from FIG. 2A. In one embodiment, the user controlled mechanism 232 includes a handle for easy operation. FIG. 2C shows optional ledges 238 for holding the reservoir 230 above the cart 210. A cover 234 is shown to selectively seal the reservoir. FIG. 2B shows a two door hinged cover, although variations such as a single removable lid, etc are within the scope of the invention. In one embodiment a port 236 is included in the reservoir 230 to permit equalization of pressure when an amount of compound is released from the reservoir 230. Among other advantages, the cover 234 keeps the compound from drying out over extended periods of time. In one embodiment the cover 234 includes a rubberized seal to enhance the sealing properties. In one embodiment, the port 236 can be selectively closed overnight to further seal the reservoir. Using embodiments such as this, a user does not need to clean the reservoir and remove all compound at the end of a work day. Any unused compound can be sealed in the reservoir 230 and used the next day.

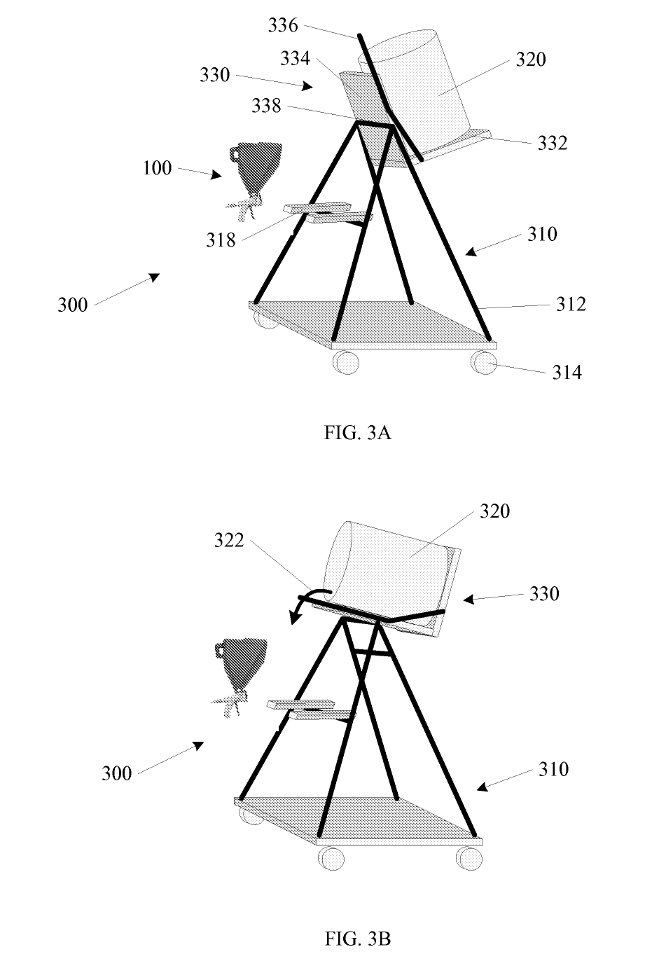

FIG. 3A shows another spray texture system 300 according to an embodiment of the invention. Similar to embodiments described above, a cart 310 is shown supporting a reservoir assembly 330. The reservoir assembly 330 shown in FIG. 3A includes a lower platform 332 and a side support 334. A commercially available container such as a five gallon pail 320 of compound is placed on the platform 332 and secured in place. In one embodiment a user controlled mechanism includes a handle 336 and a rotation joint 338 to selectively release an amount of compound.

A spray texture assembly 100 such as the example shown in FIG. 1 is included in FIG. 3A to illustrate use in conjunction with other components in FIG. 3A. A support 318 shaped to accept the spray texture assembly 100 is shown coupled to the cart 310. In use, the spray texture assembly 100 is placed on the support 318, and the support 318 holds the hopper in a substantially upright position adjacent to the reservoir 330. The reservoir contains a supply of spray texture compound (not shown) for use in periodically filling the hopper.

Similar to embodiments described above, the cart 310 in FIG. 3A includes a number of frame members 312. The cart 310 includes one or more wheels 314 to facilitate movement of the cart around a job site. In one embodiment, the cart 310 includes a folding mechanism and/or a height adjustment mechanism. FIG. 3B is included to illustrate operation of the spray texture system 300. By actuating the user controlled mechanism, an amount of compound is released as shown by arrow 322 into the hopper 120. Although selected configurations of a reservoir and user controlled mechanism are shown, the invention is not limited to the specific configurations. One of ordinary skill in the art, having the benefit of the present disclosure will recognize that other variations are possible within the scope of the invention.

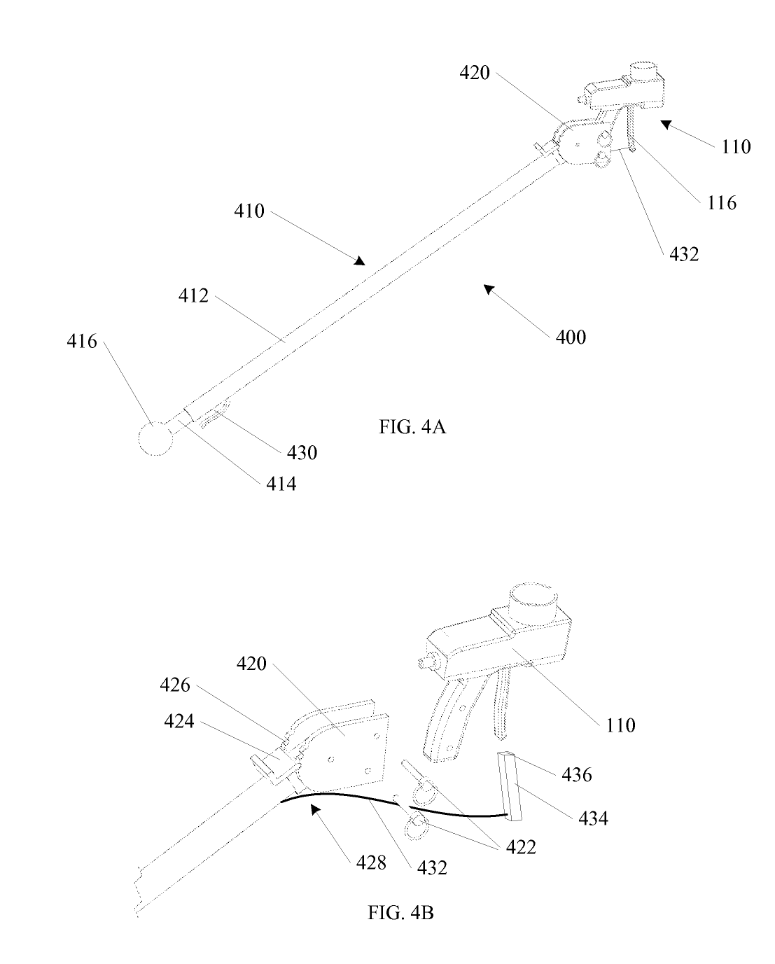

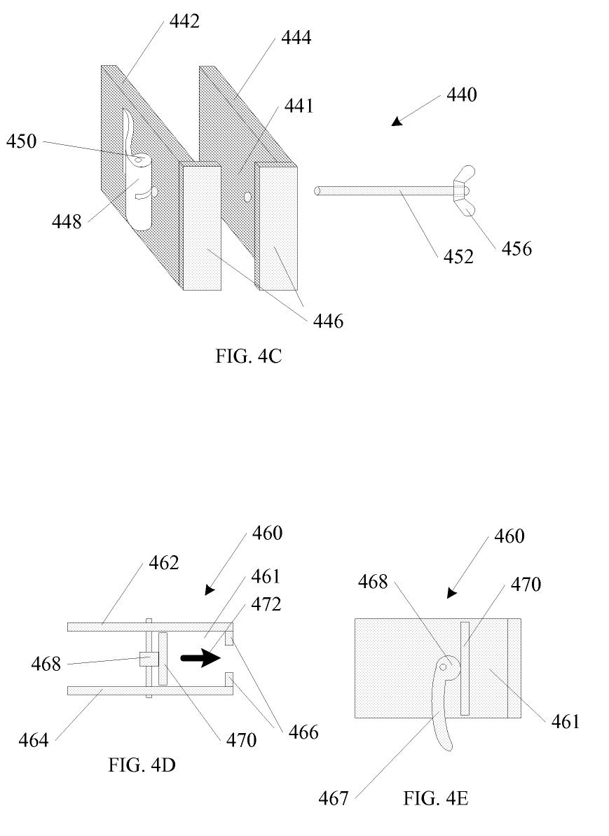

FIG. 4A shows a spray texture system 400 according to an embodiment of the invention. A spray texture gun 110 similar to the configuration shown in FIG. 1 is included in the system 400 shown in FIG. 4A. The spray texture system 400 includes an extension pole 410 with a spray gun mount 420 attached at a distal end. In one embodiment, the extension pole 410 is adjustable to a number of pole lengths, although the invention is not so limited. In one length adjustable configuration, a first pole segment 412 and a second pole segment 414 telescope within one another to provide adjustability. A proximal end 416 of the extension pole 410 is shown having a ball shaped feature that will be discussed in more detail below.

FIG. 4B shows the spray gun mount 420 utilizing at least one pin 422 to secure the spray texture gun 110 within the mount 420, however the invention is not so limited. Other examples of possible mount configurations are discussed below. In one embodiment, a quick connect device is utilized to couple the spray texture gun 110 to the mount 420. For example the pins 422 shown in FIG. 4A and 4B are quickly removed and re-inserted in contrast to more permanent fasteners such as threaded bolts or nuts. In one embodiment, an orientation joint 428 is located between the mount 420 and the extension pole 410, as shown in FIG. 4B. A user selectable lever 424 is shown that engages one of a number of slots 426 to select an angle for use. Other possible orientation joints include, but are not limited to, friction clamps, ratchets, etc.

FIGS. 4A and 4B further illustrate a remote trigger device coupled to the trigger 116. In one embodiment, the remote trigger device includes a flexible line 432 that is coupled between the trigger 116 and a remote lever 430. One of ordinary skill in the art having the benefit of the present disclosure will recognize that a number of possible remote trigger configurations are within the scope of the present invention. Examples include a spring return trigger with a pull only cable; a push/pull cable and cable housing configuration; a rigid actuation rod and linkage, hydraulic operation, etc.

In selected embodiments, the flexible line 432 is connected directly to the trigger 116. In other embodiments, the flexible line 432 is coupled to a trigger extension 434. A trigger extension 434 is useful in selected embodiments to provide additional leverage when the flexible line 432 pulls the trigger 116. In one embodiment, one or more trigger extensions 434 can be used, depending on the configuration and/or brand of spray texture gun being used in the system. One method of coupling the trigger extension 434 to the trigger 116 includes using a close fitting hole 436 in one end of the trigger extension 434. Other fastening methods are also within the scope of the invention including clamps, screws, etc.

FIG. 4C illustrates another possible spray gun mount 440 according to an embodiment of the invention. A first clamp portion 442 and a second clamp portion 444 form opposing surfaces with a clamping region 441 in between. FIG. 4C further shows front members 446 to further capture a handle of a spray texture gun. In one embodiment, a space is left open between the first clamp portion 442 and the second clamp portion 444 and the front members 446 to allow a spray texture gun trigger to fully collapse against the gun handle. The embodiment shown in FIG. 4C shows a clamping lever 448 including a cam 450. In one embodiment, a threaded member 452 passes through the first clamp portion 442 and the second clamp portion 444 and couples to the cam 450. In one configuration, a wingnut 456 or other suitable fastener is included to adjust the appropriate tension on the cam 450 and lever 448.

FIG. 4D illustrates another possible spray gun mount 460 according to an embodiment of the invention. A first clamp portion 462 and a second clamp portion 464 form opposing surfaces with a clamping region 461 in between. FIG. 4D further shows front members 466 to further capture a handle of a spray texture gun. Similar to embodiments described above, in one embodiment, a space is left open between the first clamp portion 442 and the second clamp portion 444 and the front members 446 to allow a spray texture gun trigger to fully collapse against the gun handle. A clamping lever 467 is shown with a cam 468 attached at one end. In one embodiment, the cam 468 presses against a plate 470 that in turn distributes force against a spray gun handle (not shown) along the direction shown by arrow 472.

Use of a lever and cam, removable pins, etc. provides a quick connect function for clamping and release of a spray texture gun. Although a number of variations are illustrated, the invention is not so limited. Other configurations of clamps, or other quick connect clamps are included within the scope of the invention. Further, combinations of embodiments shown are also within the scope of the invention. For example, a side clamp similar to the configuration shown in FIG. 4C can be combined with a rear clamp configuration such as shown in FIG. 4D and 4E.

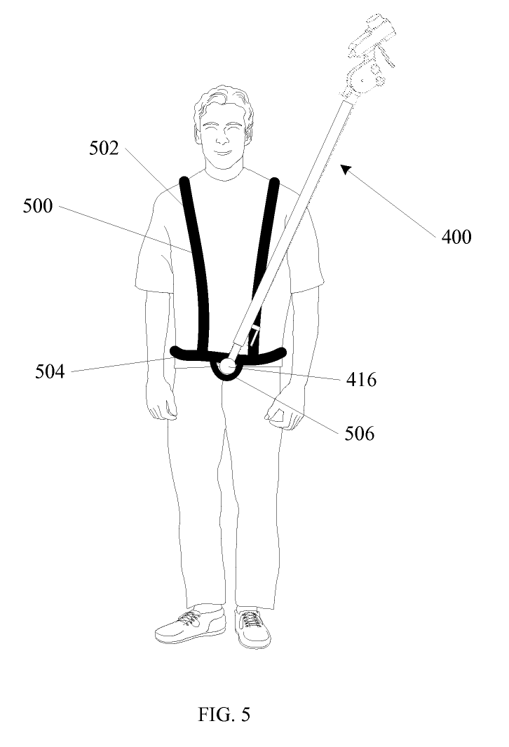

FIG. 5 illustrates how selected embodiments of spray texture systems interact with a user. Prior spray texture product designs were heavy, and required considerable effort by a user to hold and point the gun during a job. As illustrated in FIG. 5, a spray texture system 400 similar to embodiments described above, directs a portion of the weight from the gun and/or hopper through the extension pole down to a harness 500 that is worn by a user. The harness 500 shown in FIG. 5 includes a coupling 506 to accept an end of the extension pole. In one embodiment, a ball 416 is included on a proximal end of the extension pole to further facilitate movement of the extension pole in relation to the harness 500. Although a number of configurations of harness 500 are possible, FIG. 5 illustrates both a waist strap 504 and shoulder straps 502. The use of multiple straps in the harness 500 further spreads the load of the spray texture gun and/or hopper over multiple portions of the user's body such as shoulders and waist.

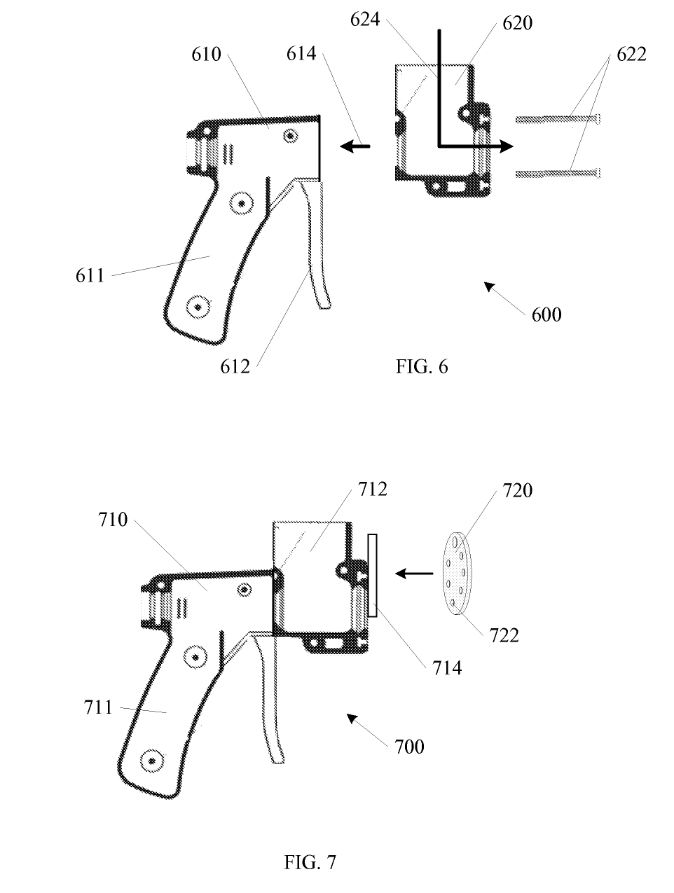

FIG. 6 illustrates a spray texture system 600 according to an embodiment of the invention. A body portion 610 is shown with a handle 611. A trigger 612 is used to selectively operate the gun. A removable chamber 620 is shown that is attachable to the body 610 in the direction of arrow 614. A fastening system such as a number of screws 622 are shown to selectively couple the chamber 620 to the body 610. Other fastening systems such as levers, cams, alternate fasteners, etc. are also within the scope of the invention. An advantage of having a removable chamber includes the ability to optimize flow rates for a variety of compounds. For example, higher viscosity compounds may require a larger chamber 620 with higher flow rates along direction 620 as illustrated. Further variations in replaceable chambers include chamber materials that are resistant to damage from other compounds such as abrasive stucco, or corrosive compounds, etc. By making the chamber replaceable or interchangeable, a number of possible compounds cam be sprayed with the same gun body 610.

FIG. 7 illustrates another spray texture system 700 according to an embodiment of the invention. A body portion 710 is shown with a handle 711. A trigger 712 is used to selectively operate the gun. In one embodiment, the spray texture system 700 includes a removable chamber as described above, however a one piece spray texture system 700 can be used as well. A nozzle assembly 714 is shown coupled to a chamber of the system 700. In one embodiment, the nozzle assembly includes a wheel with a number of selectable nozzle diameters. In another embodiment, the nozzle assembly includes a single nozzle that is replaceable, Other nozzles such as permanent nozzles are included in the scope of the invention as well. A seal 720 is shown that matches the particular nozzle assembly and prevents drying out of compound material. The use of a seal allows a user to leave the spray gun at the end of a work day, without time consuming cleaning. The seal can be easily removed the next work day, and the compound will not be dried out, thus allowing the user to continue work. Examples of seals include polymers such as elastomer materials (silicone, etc.) that provide a sufficient seal to prevent drying of the compound.

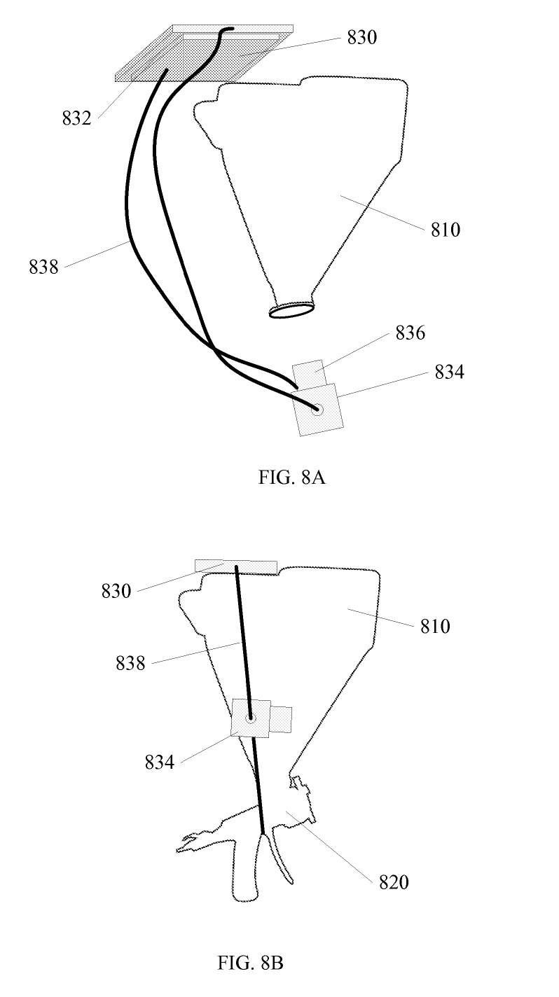

FIG. 8A further illustrates portions of a spray texture system that prevent drying out of compound overnight or otherwise during periods of inactivity. A hopper 810 is illustrated in FIG. 8A. In one embodiment a top seal 830 is configured to cover a top opening in the hopper 810. In one embodiment a flange 832 is included in the top seal to help position the top seal, and to more effectively seal the hopper. A bottom seal 834 is also illustrated. In one embodiment, the bottom seal 834 includes a flange 836 that also serves to locate the bottom seal 834 and improve the sealing function. A securing cord 838 is shown to hold the top seal 830 and the bottom seal 834 in place. In one embodiment, the securing cord includes a bungee or other elastic cord. Other embodiments include a length adjustable cord with a fastener, etc. The system illustrated in FIG. 8A can be used to seal a hopper by itself without cleaning at the end of a work day. The compound material remains moist, and can therefore be used again the next work day.

FIG. 8B shows the spray texture system of FIG. 8A used in conjunction with a hopper 810 and spray gun 820. As shown, the top seal selectively covers the top opening of the hopper, while the bottom seal 843 can be moved out of position and the cord 838 is held against the gun 820. In one embodiment to further seal the system as shown in FIG. 8B, a nozzle seal as described above such as in FIG. 7 can be used.

Embodiments of spray texture systems, spray texture system components, and methods as described above have a number of advantages. One advantage includes the ability to easily refill a hopper. Another advantage includes a system that is easier to support and spreads the weight of system components to other parts of a user's body. Another advantage includes seals that prevent drying out of compound, allowing a user to clean equipment less frequently. Other improvements described allow spraying of multiple types of compound, and provide inexpensive devices with the flexibility to handle multiple types of compound spraying jobs.

While a number of advantages of embodiments of the invention are described, the above lists are not intended to be exhaustive. Although specific embodiments have been illustrated and described herein, it will be appreciated by those of ordinary skill in the art that any arrangement which is calculated to achieve the same purpose may be substituted for the specific embodiment shown. This application is intended to cover any adaptations or variations of the present invention. It is to be understood that the above description is intended to be illustrative, and not restrictive. Combinations of the above embodiments, and other embodiments will be apparent to those of skill in the art upon reviewing the above description. The scope of the invention includes any other applications in which the above structures and methods are used. The scope of the invention should be determined with reference to the appended claims, along with the full scope of equivalents to which such claims are entitled.

I claim:

1. A spray texturing system, comprising:
a reservoir;
a cart structure to support the reservoir above the ground;
at least one support to hold a spray texture gun and hopper in position adjacent to the reservoir; and
a user controlled mechanism to selectively release an amount of spray texture compound from within the reservoir into the hopper.

2. The spray texturing system of claim 1, wherein the reservoir includes a pail of pre-mixed spray texture compound.

3. The spray texturing system of claim 2, wherein the user controlled mechanism includes a joint to rotate the pail from a substantially upright orientation to a pouring orientation.

4. The spray texturing system of claim 1, wherein the user controlled mechanism includes a port to allow a gravity feed stream of spray texture compound.

5. The spray texturing system of claim 1, wherein the support to hold the spray texture gun and hopper in position adjacent to the reservoir includes at least one support to hold the spray texture gun and hopper in position substantially below the reservoir.

6. The spray texturing system of claim 1, further including wheels on a base of the cart structure.

7. The spray texturing system of claim 1, further including a height adjustment linkage connected between the cart and the reservoir to selectively raise or lower the reservoir a distance above the ground.

8. The spray texturing system of claim 1, further including a removable cover to prevent air from drying out the spray texture compound.

9. A spray texturing system, comprising:
a reservoir;
a cart structure to support the reservoir above the ground;
at least one support to hold a spray texture gun and hopper in position adjacent to the reservoir; and
a port to selectively release a gravity feed stream of spray texture compound from within the reservoir into the hopper.

10. The spray texturing system of claim 9, wherein the support to hold the spray texture gun and hopper in position adjacent to the reservoir includes at least one support to hold the spray texture gun and hopper in position substantially below the reservoir.

11. A spray texturing system, comprising:
a reservoir holder;
a cart structure to support the reservoir holder above the ground;
at least one support to hold a spray texture gun and hopper in position adjacent to the reservoir holder; and
a mechanical linkage to move the reservoir holder through a range of motion, wherein the range includes a first position to support a pail of pre-mixed spray texture compound substantially upright, and a second position to pour an amount of spray texture compound from the pail.

12. The spray texturing system of claim 11, wherein the mechanical linkage includes a hinge with lever for a user to pull.

13. The spray texturing system of claim 11, wherein the reservoir holder is adapted to hold a five gallon pail of pre-mixed spray texture compound.

14. A spray texturing system, comprising:
an extension pole having a first end and a second end, wherein the first end includes a mount to accept a spray texture gun;
a harness, including a coupling to accept the second end of the extension pole, wherein the harness transfers a portion of the weight of the spray texture gun through the extension pole to a users body.

15. The spray texturing system of claim 14, wherein the harness transfers a portion of the weight of the spray texture gun to a user's waist.

16. The spray texturing system of claim 14, wherein the harness transfers a portion of the weight of the spray texture gun to a user's shoulders.

17. The spray texturing system of claim 14, wherein the harness transfers a portion of the weight of the spray texture gun to both a user's waist and a users shoulders.

18. The spray texturing system of claim 14, further comprising a remote trigger device to couple to a trigger on the spray texture gun for remote operation of the spray texture gun.

19. The spray texturing system of claim 14, wherein the mount to accept a spray texture gun includes a quick connect mount that is adaptable to a number of spray texture gun configurations.

20. The spray texturing system of claim 14, wherein the mount to accept a spray texture gun includes at least one orientation joint to selectively adjust an angle of the spray texture gun with respect to the extension pole.

21. The spray texturing system of claim 14, wherein an extension pole length is adjustable.

22. A spray texturing system, comprising:
a reservoir;
a cart structure to support the reservoir above the ground;
a spray texture gun assembly, including:
a spray texture gun;
a hopper coupled to the spray texture gun;
an extension pole having a first end and a second end, wherein the spray texture gun assembly is attached to the extension pole adjacent to the first end;
a harness, including a coupling to accept the second end of the extension pole, wherein the harness transfers a portion of the weight of the spray texture gun assembly through the extension pole to a users body;
at least one support to hold the spray texture gun assembly in position adjacent to the reservoir; and
a user controlled mechanism to selectively release an amount of spray texture compound from within the reservoir into the hopper.

23. The spray texturing system of claim 22, further comprising a remote trigger device to couple to a trigger on the spray texture gun for remote operation of the spray texture gun.
